(19) United States
(12) Patent Application Publication
(10) Pub. No.: US 2012/0172547 A1
(43) Pub. Date: Jul. 5, 2012

(54) Cross-linked Polyphosphonate, Method of Preparing the Same, and Flame Retardant Thermoplastic Resin Composition Including the Same

(75) Inventors: Seon Ae LEE, Uiwang-si (KR); Chang Hong KO, Uiwang-si (KR); Sang Hyun HONG, Uiwang-si (KR); Min Soo LEE, Uiwang-si (KR)

(73) Assignee: CHEIL INDUSTRIES INC., Gumi-si (KR)

(21) Appl. No.: 13/325,210

(22) Filed: Dec. 14, 2011

(30) Foreign Application Priority Data
Dec. 29, 2010 (KR) 10-2010-0138353

(51) Int. Cl. C08L 85/02; C08G 79/04

(52) U.S. Cl. 525/534; 528/167

(57) ABSTRACT

A cross-linked polyphosphonate and a thermoplastic resin composition including the cross-linked polyphosphonate are disclosed. The composition may have excellent flame retardancy and mechanical strength and superior appearance and heat resistance.

### CROSS-REFERENCE TO RELATED APPLICATIONS

This application claims priority under 35 USC Section 119 to and the benefit of Korean Patent Application No. 10-2010-0138353 filed Dec. 29, 2010, the entire disclosure of which is incorporated herein by reference.

### FIELD OF THE INVENTION

The present invention relates to cross-linked polyphosphonate, a method of preparing the same, and a flame retardant thermoplastic resin composition including the same.

### BACKGROUND OF THE INVENTION

To impart flame retardancy without using halogen flame retardants, phosphorus flame retardants can be used. Conventionally, monomolecular phosphorus flame retardants, such as triphenyl phosphate and resorcinol bisphenol phosphate are used. However, such monomolecular phosphorus flame retardants have a low molecular weight and thus volatilize at high molding temperatures, which can deteriorate the appearance of the plastic product. Further, monomolecular phosphorus flame retardants may escape into the outside environment during use of products containing the same, which can cause environmental contamination.

Accordingly, polyphosphonate has received increasing attention as a polymerizable phosphorus flame retardant. Polyphosphonate in a polymer form can exhibit excellent flame retardancy, mechanical properties, heat resistance, and transparency and can be highly compatible with a polymer resin as compared with a monomolecular phosphorus flame retardant. Accordingly polyphosphonate can be used in resins requiring high heat resistance and high transparency, such as polycarbonate resins.

Such polyphosphonate may be prepared by deoxidation of a diol and phosphonic dichloride. In this reaction, linear polyphosphonate is produced. The linear polyphosphonate can exhibit excellent flame retardancy, but can provide limited improvements in heat resistance and impact strength.

### SUMMARY OF THE INVENTION

The present invention provides a cross-linked polyphosphonate which can provide excellent flame retardancy even when present in a small amount, does not emit a halogenated gas and thus is environmentally friendly, does not volatilize into a monomolecular flame retardant, and can exhibit an excellent balance of physical properties such as flame retardancy, impact strength, heat resistance, appearance, and fluidity when used in a thermoplastic resin. The present invention also provides a method of preparing the same and a flame retardant thermoplastic resin composition including the same as a flame retardant which can exhibit an excellent balance of physical properties including flame retardancy, mechanical strength, appearance, and heat resistance.

The cross-linked polyphosphonate can include a unit represented by Formula 1:

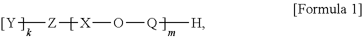

wherein:

Z is a greater than trivalent C1 to C30 hydrocarbon residue, each Y is the same or different and is independently hydrogen, C1 to C5 linear or branched alkyl, C5 to C6 cycloalkyl or C6 to C20 aryl, each X is the same or different and is independently C1 to C5 linear or branched alkylene, C5 to C6 cycloalkylene or C6 to C20 arylene, each Q is the same or different and is independently

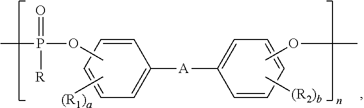

where A is a single bond, C1 to C5 alkylene, C1 to C5 alkylidene, C5 to C6 cycloalkylidene, —S— or —SO2-, R is C1 to C10 alkyl, C6 to C20 aryl or C6 to C20 aryloxy, R₁ and R₂ are the same or different and are each independently substituted or unsubstituted C1 to C6 alkyl, substituted or unsubstituted C3 to C6 cycloalkyl, substituted or unsubstituted C6 to C12 aryl or halogen, a and b are the same or different and are each independently an integer from 0 to 4, and n is an integer from 5 to 2,000,

k is an integer from 0 to 10, and

m is an integer from 3 to 10.

Z may be a greater than trivalent C1 to C30 alkyl radical, a greater than trivalent C5 to C30 cycloalkyl radical or a C6 to C30 aryl radical.

The cross-linked polyphosphonate may have a solubility of about 0 to about 0.0001 g/10 ml in tetrahydrofuran when deposited at 25° C. for 17 hours.

In one embodiment, the cross-linked polyphosphonate may have a weight average molecular weight of about 1,000 to about 300,000 g/mol.

In one embodiment, Q may be present in an amount of about 50 to about 98 wt % based on the total weight of the cross-linked polyphosphonate.

The present invention also provides a method of preparing the cross-linked polyphosphonate. The method includes polymerizing a diol and phosphonic dichloride with a crosslinker represented by Formula 4:

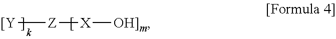

wherein:

Z is a greater than trivalent C1 to C30 hydrocarbon residue,

each Y is the same or different and is independently hydrogen, C1 to C5 linear or branched alkyl, C5 to C6 cycloalkyl or C6 to C20 aryl,

each X is the same or different and is independently C1 to C5 linear or branched alkyl, C5 to C6 cycloalkyl or C6 to C20 aryl,

k is an integer from 0 to 10, and

m is an integer from 3 to 10.

The crosslinker may be reacted with the phosphonic dichloride in an equivalent ratio of about 0.01:1 to about 1:1.

In one embodiment, polymerization may be carried out in the presence of a basic catalyst.

In another embodiment, the polymerization may be carried out using interfacial polymerization in the presence of at least one catalyst comprising tetrabutylammonium iodide, tetrabutylammonium bromide, benzyltriphenylphosphonium chloride or a combination thereof.

The method may further include adjusting a terminal group using a phenolic compound.

In one embodiment, the phenolic compound may be reacted with phosphonic dichloride in an equivalent ratio of about 0.03:1 to about 0.3:1.

The present invention also provides a flame retardant thermoplastic resin composition including the cross-linked polyphosphonate.

In one embodiment, the composition may include about 0.01 to about 30 parts by weight of the cross-linked polyphosphonate based on about 100 parts by weight of thermoplastic resin.

The flame retardant thermoplastic resin composition may have an IZOD impact strength of about 80 kgf·cm/cm or more as measured on a ⅛″ thick specimen according to ASTM D256, a total combustion time of less than about 3 seconds as measured on a ⅛″ thick specimen according to UL-94, and a Vicat softening temperature (VST) of about 150° C. or higher as measured using a 5 kg weight according to ISO R 306.

### BRIEF DESCRIPTION OF THE FIGURES

FIG. 1 is a proton NMR analysis of a cross-linked polyphosphate prepared in the Preparation Example; and

FIG. 2 is a Fourier Transform Infrared Spectrometry analysis of the cross-linked polyphosphate prepared in the Preparation Example.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

Cross-linked polyphosphonate according to exemplary embodiments of the present invention includes a unit represented by Formula 1:

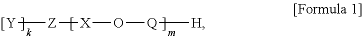

wherein:

Z is a greater than trivalent C1 to C30 hydrocarbon residue,

each Y is the same or different and is independently hydrogen, C1 to C5 linear or branched alkyl, C5 to C6 cycloalkyl or C6 to C20 aryl,

each X is the same or different and is independently C1 to C5 linear or branched alkylene, C5 to C6 cycloalkylene or C6 to C20 arylene,

each Q is the same or different and is independently

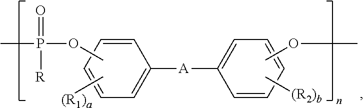

wherein A is a single bond, C1 to C5 alkylene, C1 to C5 alkylidene, C5 to C6 cycloalkylidene, —S— or —SO2-, R is C1 to C10 alkyl, C6 to C20 aryl or C6 to C20 aryloxy, R₁ and R₂ are the same or different and are each independently substituted or unsubstituted C1 to C6 alkyl, substituted or unsubstituted C3 to C6 cycloalkyl, substituted or unsubstituted C6 to C12 aryl or halogen, a and b are the same or different and are each independently an integer from 0 to 4, and n is an integer from 5 to 2,000,

k is an integer from 0 to 10, and

m is an integer from 3 to 10.

As used herein, the “greater than trivalent C1 to C30 hydrocarbon residue” of Z refers to a greater than trivalent C1 to C30 alkyl radical, a greater than trivalent C5 to C30 cycloalkyl radical, or a C6 to C30 aryl radical. In exemplary embodiments, Z may be a tetravalent to heptavalent, for example, tetravalent or pentavalent, C1 to C30 alkyl radical, a C5 to C30 cycloalkyl radical, or a C6 to C30 aryl radical.

As used herein, the term “substituted” means that a hydrogen atom of a compound is substituted by a halogen atom, such as F, Cl, Br, and I, a hydroxyl group, a nitro group, a cyano group, an amino group, an azido group, an amidino group, a hydrazino group, a hydrazono group, a carbonyl group, a carbamyl group, a thiol group, an ester group, a carboxyl group or salt thereof, a sulfonic acid group or salt thereof, a phosphate group or salt thereof, a C1 to C20 alkyl group, a C2 to C20 alkenyl group, a C2 to C20 alkynyl group, a C1 to C20 alkoxy group, a C6 to C30 aryl group, a C6 to C30 aryloxy group, a C3 to C30 cycloalkyl group, a C3 to C30 cycloalkenyl group, a C3 to C30 cycloalkynyl group, or a combination thereof.

In exemplary embodiments, k may be an integer from 0 to 2.

In exemplary embodiments, n may be an integer from 10 to 1,500.

In exemplary embodiments, m may be an integer from 3 to 5.

In exemplary embodiments, Z may be represented by the following units:

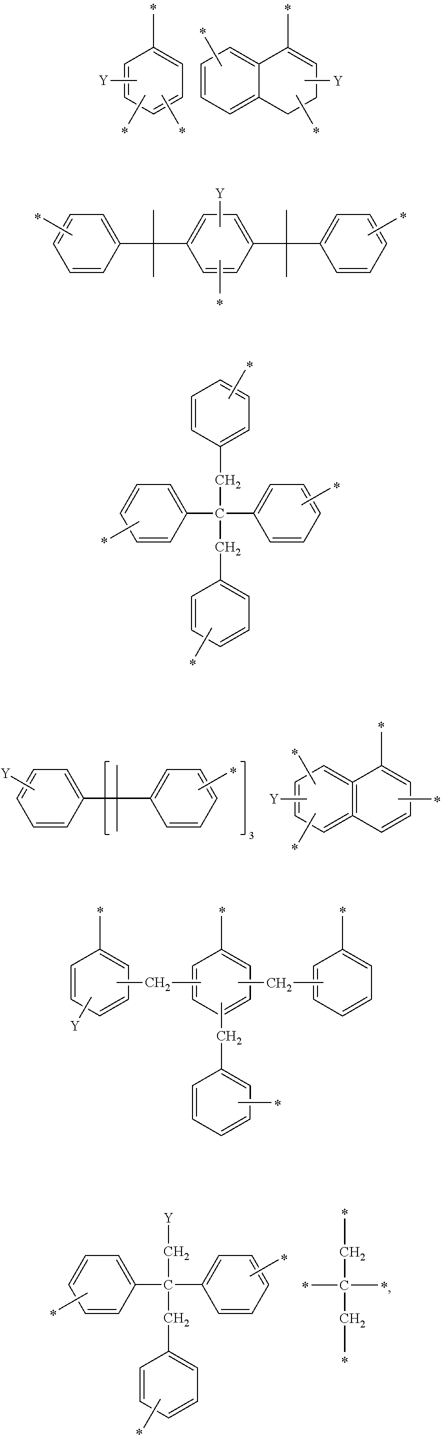

wherein * is

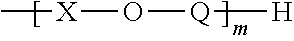

as defined herein and wherein Y is the same defined herein.

In an exemplary embodiment, Formula 1 may have a unit represented by Formula 1-1:

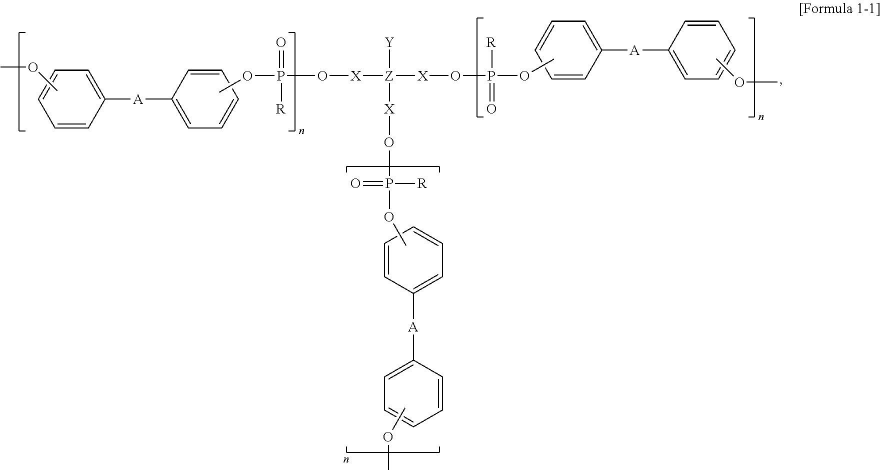

wherein:

Z is C1 to C5 linear or branched alkyl, C5 or C6 cycloalkyl, or C6 to C20 aryl,

Y is hydrogen, C1 to C5 linear of branched alkyl, C5 or C6 cycloalkyl, or C6 to C20 aryl,

each X is the same or different and is independently C1 to C5 linear or branched alkylene, C5 or C6 cycloalkylene, or C6 to C20 arylene,

each A is the same or different and is independently a single bond, C1 to C5 alkylene, C1 to C5 alkylidene, C5 or C6 cycloalkylidene, —S—, or —SO2-,

each R the same or different and is independently is C1 to C10 alkyl, C6 to C20 aryl, or C6 to C20 aryloxy, and

each n is the same or different and is independently an integer from 5 to 2,000.

The cross-linked polyphosphonate can have a solubility of about 0 to about 0.0001 g/10 ml in tetrahydrofuran when deposited at 25° C. for 17 hours. In contrast, a linear polyphosphonate can have a solubility of about 0.01 to about 0.4 g/10 ml in tetrahydrofuran when deposited at 25° C. for 17 hours.

The cross-linked polyphosphonate may have a weight average molecular weight of about 1,000 to about 300,000 g/mol. In the present invention, the weight average molecular weight is measured by GPC using a Waters 515.

In one embodiment, a unit Q may be present in an amount of about 50 to about 98 wt %, for example about 60 to about 90 wt %, based on the total weight of the cross-linked polyphosphonate. In some embodiments, the cross-linked polyphosphonate may include the unit Q in an amount of about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, or 98 wt %. Further, according to some embodiments of the present invention, the amount of the unit Q can be in a range from about any of the foregoing amounts to about any other of the foregoing amounts.

When the unit Q is present in an amount within this range, the resin composition can exhibit excellent flame retardancy and a balance of properties.

The cross-linked polyphosphonate may be prepared by polymerization of a diol and phosphonic chloride with a polyol having at least three hydroxyl groups as a crosslinker.

In one embodiment, the diol may be represented by Formula 2:

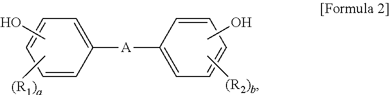

wherein:

A is a single bond, C1 to C5 alkylene, C1 to C5 alkylidene, C5 to C6 cycloalkylidene, —S— or —SO2-,

R₁ and R₂ are the same or different and are each independently substituted or unsubstituted C1 to C6 alkyl, substituted or unsubstituted C3 to C6 cycloalkyl, substituted or unsubstituted C6 to C12 aryl or halogen, and

a and b are the same or different and are each independently an integer from about 0 to about 4.

Examples of the diol may include without limitation 4,4′-dihydroxydiphenyl, 2,2-bis-(4-hydroxyphenyl)-propane, 2,4-bis-(4-hydroxyphenyl)-2-methylbutane, 1,1-bis-(4-hydroxyphenyl)-cyclohexane, 2,2-bis-(3-chloro-4-hydroxyphenyl)-propane, 2,2-bis-(3,5-dichloro-4-hydroxyphenyl)-propane, and the like, and combinations thereof. Further, as a diphenol compound, hydroquinone, resorcinol, and the like, and combinations thereof may be used. In exemplary embodiments, 2,2-bis-(4-hydroxyphenyl)-propane, 2,2-bis-(3,5-dichloro-4-hydroxyphenyl)-propane, 1,1-bis-(4-hydroxyphenyl)-cyclohexane, and the like and combinations thereof, for example 2,2-bis-(4-hydroxyphenyl)-propane, may be used.

The phosphonic dichloride may be represented by Formula 3:

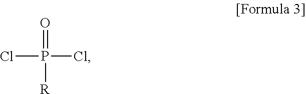

wherein R is C6 to C20 aryl or C6 to C20 aryloxy.

In exemplary embodiments, the phosphonic dichloride may be reacted with the diol in an equivalent ratio of about 1 to about 1.

The crosslinker may be represented by Formula 4:

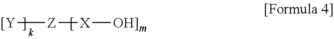

wherein:

Z is a greater than trivalent C1 to C30 hydrocarbon residue,

each Y is the same or different and is independently hydrogen, C1 to C5 linear or branched alkyl, C5 to C6 cycloalkyl or C6 to C20 aryl,

each X is the same or different and is independently C1 to C5 linear or branched alkyl, C5 to C6 cycloalkyl or C6 to C20 aryl,

k is an integer from 0 to 10, and

m is an integer from 3 to 10.

Z may be a greater than trivalent C1 to C30 alkyl radical, a greater than trivalent C5 to C30 cycloalkyl radical, or a greater than trivalent C6 to C30 aryl radical. In exemplary embodiments, Z may be a tetravalent to heptavalent, for example, tetravalent or pentavalent, C1 to C30 alkyl radical, a greater than trivalent C5 to C30 cycloalkyl radical, or a C6 to C30 aryl radical.

In exemplary embodiments, k may be an integer from 0 to 2.

In exemplary embodiments, m may be an integer from 3 to 5.

Examples of the crosslinker may include without limitation 1,1,1-tris(4-hydroxyphenyl)ethane, 3- or 4-hydroxy aromatic compounds such as 4-hydroxybutyl acrylate, trimethylolpropane, trimethylolethane, pentaerythritol, oxypropylated ethylene diamine, ditrimethylolpropane, dipentaerythritol, glycerin, and the like. These crosslinkers may be used alone or in combination of two or more thereof.

The crosslinker may be reacted with the phosphonic dichloride in an equivalent ratio of about 0.01:1 to about 1:1. When the crosslinker and the phosphonic dichloride are reacted in amounts within this ratio, post-treatment can be simplified.

In one embodiment, reaction of the diol and the phosphonic dichloride may be carried out in the presence of a basic catalyst. Examples of the basic catalyst can include without limitation dimethylaminopyridine, alkali metal hydroxides, and the like, and combinations thereof. The catalyst may be reacted with the phosphonic dichloride in an equivalent ratio of about 0.03:1 to about 0.3:1, for example about 0.05:1 to about 0.1:1. The amount of the cross-linked polyphosphonate may increase depending on the amount of the catalyst. However, if the equivalent ratio of the catalyst and the phosphonic dichloride is greater than about 0.3:1, the increase in the rate of reaction can be decreased.

In another embodiment, polymerization may be carried out by interfacial polymerization using a phase transfer catalyst. Examples of the phase transfer catalyst may include without limitation tetrabutylammonium iodide, tetrabutylammonium bromide, benzyltriphenylphosphonium chloride, and the like, and combinations thereof. In exemplary embodiments, benzyltriphenylphosphonium chloride may be used.

The reaction may be carried out at a temperature of about −40 to about 40° C., for example about −10 to about 5° C. Further, the reaction may be carried out in a nitrogen atmosphere. Reaction time may be about 1 to about 24 hours, for example about 2 to about 3 hours.

Solvents that can be used in the reaction may include without limitation methylene chloride, 1,2-dichloroethane, dichlorobenzene, and the like, and combinations thereof. In one embodiment, dichloroethane and water may be used together.

In one embodiment, hydrochloric acid generated in the course of polymerization may be neutralized with an alkali solution. Examples of the alkali solution may include without limitation sodium hydroxide solution, potassium hydroxide solution and the like, and combinations thereof.

In another embodiment, after the polymerization reaction is terminated, adjusting a terminal group with a phenolic compound may further be carried out. In one embodiment, the phenolic compound may be reacted with the phosphonic dichloride in an equivalent ratio of about 0.03:1 to about 0.3:1, for example about 0.04:1 to about 0.08:1. 4-cumylphenol may be used as the phenolic compound.

Alternatively, after the polymerization reaction is terminated, post-treatment with alkylene oxide may further be carried out. The alkylene oxide may be added in an equivalent amount of about 2 to about 7, for example about 3 to about 5 of the acid value of the reaction product. By conducting post-treatment with the alkylene oxide, the acid value of the final product may be significantly reduced and decomposition of a mixed resin may be prevented.

The cross-linked polyphosphonate thus prepared may be obtained via washing, solidification, and drying.

The present invention further relates to a flame retardant thermoplastic resin composition including cross-linked polyphosphonate.

In one embodiment, the composition may include about 0.01 to about 30 parts by weight, for example about 0.1 to 15 parts by weight, and as another example about 0.5 to about 10 parts by weight, of the cross-linked polyphosphonate based on about 100 parts by weight of a thermoplastic resin. In some embodiments, the composition may include the cross-linked polyphosphonate in an amount of about 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 parts by weight. Further, according to some embodiments of the present invention, the amount of the cross-linked polyphosphonate can be in a range from about any of the foregoing amounts to about any other of the foregoing amounts.

There is no particular limitation as to the kind of the thermoplastic resin. Examples of the thermoplastic resin may include without limitation styrene resins, polyester resins, (meth)acrylate resins, polyamide resins, polyphenylene ether resins, polycarbonate resins, polyolefin resins, polyvinyl chloride resins, and the like. These resins may be used alone or in combination of two or more thereof. The cross-linked polyphosphonate prepared by the method according to the present invention can exhibit excellent mechanical strength and can have flame retardancy, heat resistance and transparency and thus may be properly added to resins requiring high heat resistance and high transparency, for example polycarbonate.

In one embodiment, the flame retardant thermoplastic resin composition may have an IZOD impact strength of about 80 kgf·cm/cm or more measured on a ⅛″ thick specimen according to ASTM D256, a total combustion time of less than about 3 seconds as measured on a ⅛″ thick specimen according to UL-94, and a Vicat softening temperature (VST) of about 150° C. or higher as measured using a 5 kg weight according to ISO R 306.

For example, the flame retardant thermoplastic resin composition may have an IZOD impact strength of about 82 to about 150 kgf·cm/cm or more as measured on a ⅛″ thick specimen according to ASTM D256, a total combustion time of less than about 0 to about 2 seconds as measured on a ⅛″ thick specimen according to UL-94, and a Vicat softening temperature (VST) of about 150 to about 180° C. or higher as measured using a 5 kg weight according to ISO R 306.

The thermoplastic resin composition having excellent flame retardancy may further include one or more additives depending on the purpose thereof. Examples of the additive may include without limitation auxiliary flame retardants, lubricants, plasticizers, heat stabilizers, anti-dripping agents, antioxidants, compatibilizers, light stabilizers, pigments, dyes, inorganic additives, and the like. These additives may be used alone or in combination of two or more thereof. Examples of the inorganic additive may include without limitation asbestos, glass fiber, talc, ceramic, sulfates, and the like, and combinations thereof. The composition may include the additive in an amount of about 30 parts by weight or less, for example about 0.01 to about 25 parts by weight, based on about 100 parts by weight of the base resin.

The thermoplastic resin composition having excellent flame retardancy may be prepared by any conventional method for preparing a resin composition. For example, the components and optional additive(s) may be mixed at the same time and melt-extruded into pellets or chips using an extruder.

The invention further provides a plastic molded article formed of the thermoplastic resin composition that can have excellent flame retardancy. The thermoplastic resin composition can have excellent flame retardancy and superior heat resistance and thus may be widely used for manufacturing housings of electric and electronic products, such as TVs, stereo systems, cellular phones, digital cameras, navigation systems, washing machines, computers, monitors, MP3 players, video players, CD players and dishwashers, office automation equipment, and other large-sized injection molded products.

There is no particular limitation as to a method of molding a plastic molded article using the thermoplastic resin composition. For example, extrusion, injection, or casting molding methods may be used. The molding may be readily carried out by a person having ordinary skill in the art to which the present invention pertains.

The present invention will be explained in more detail with reference to the following examples. These examples are provided for illustrative purposes only and are not to be in any way construed as limiting the present invention.

### EXAMPLES

### Preparation Example

### Preparation of Cross-Linked Polyphosphonate

2,2-bis-(4-hydroxyphenyl)-propane (100 g, 0.438 mol), 1,1,1-tris(4-hydroxyphenyl)ethane (2.68 g, 0.009 mol) and phenol (4.12 g, 0.44 mol) are dissolved in a 1N aqueous potassium hydroxide solution, and then the mixture solution is cooled to 0° C. Phenylphosphonic dichloride (85.4 g, 0.438 mol) and methylene chloride are gently dropped to the mixture solution and stirred for 2 hours. The product is washed twice with methylene chloride and distilled water. Then, a methylene chloride layer is isolated, concentrated under reduced pressure, and deposited in hexane, thereby obtaining white solid cross-linked polyphosphonate at a yield of 92%.

The produced cross-linked polyphosphonate is analyzed as follows.

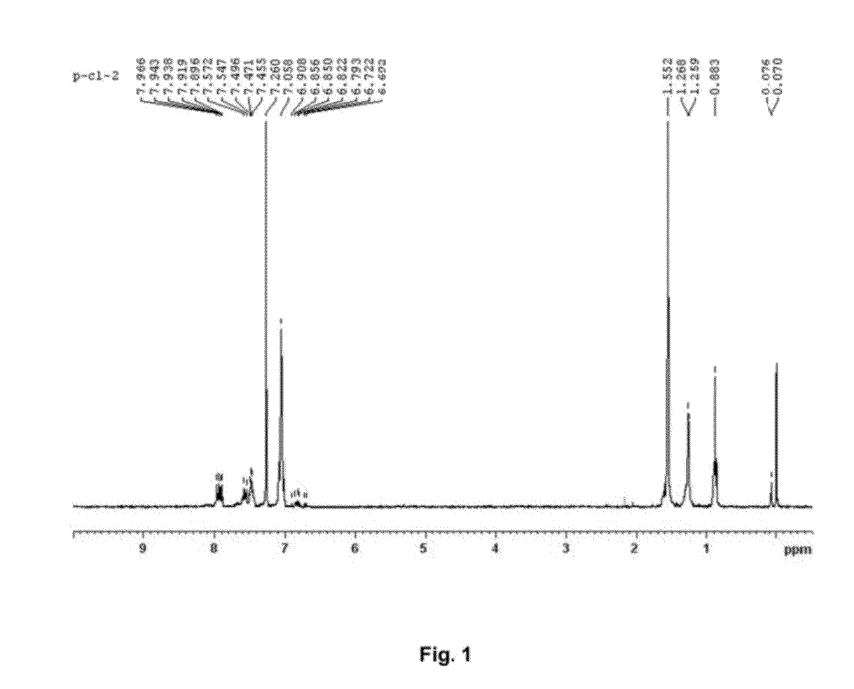

(1) Proton NMR: NMR from Bruker AVANCE III & Ultrashield Magnet is used, and the results are shown in FIG. 1.

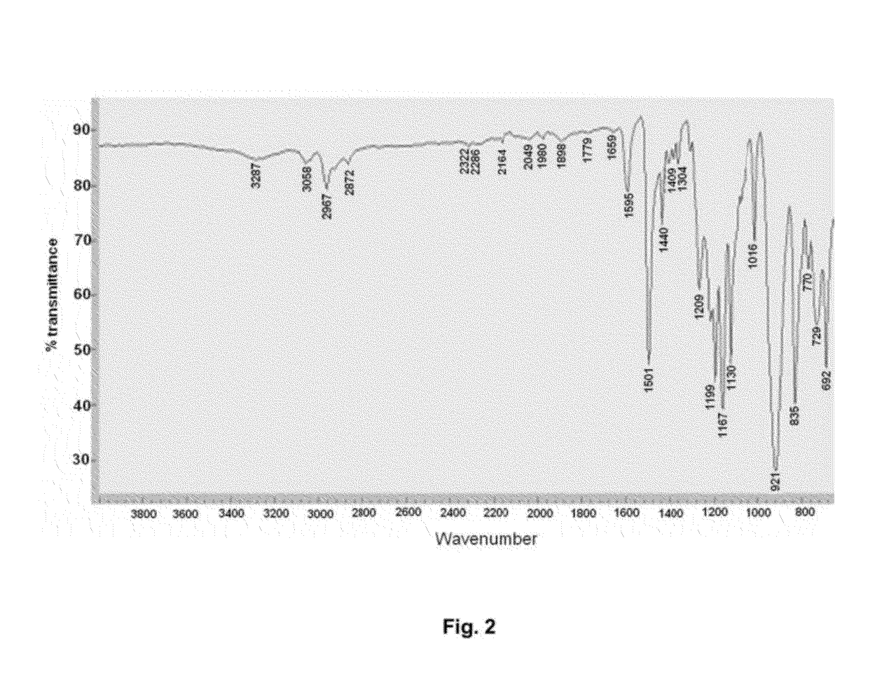

(2) IR: A Fourier Transform Infrared Spectrometer is used, and the results are shown in FIG. 2.

(3) Molecular weight (g/mol): Number average molecular weight (Mn) and weight average molecular weight (Mw) are measured by GPC (using WATERS 515 and Shodex LF-804 columns), after which PDI (Mw/Mn) is calculated and the results are shown in Table 1.

(4) Thermogravimetric analysis: Thermogravimetric analysis (TGA, Equipment: METTLER TOLEDO) and differential scanning calorimetry (DSC, Equipment: DSC Q100 TA INSTRUMENTS) are used, and the results are shown in Table 1.

(5) Solubility: The cross-linked polyphosphonate prepared in Preparative Example is deposited in tetrahydrofuran at 25° C. for 17 hours, followed by measuring solubility.

TABLE 1

| | | | Thermogravimetric analysis | | | |
|---|---|---|---|---|---|---|
| Molecular | | | | Char | | |
| weight | | | Temperature | percentage | Transition | Solubility |
| (Kg/mol) | | | of fast | at | Temp- | in THF |
| Mn | Mw | PDI | degradation | 700° C. | erature | mg/100 ml |
| 21 | 56 | 2.7 | 330° C.-630° C. | 18 wt % | 116° C. | 2 |

### Examples 1 to 3

### Preparation of Thermoplastic Resin Composition

The cross-linked polyphosphonate prepared in Preparative Example is added in the amounts listed in Table 2 to 100 parts by weight of a polycarbonate having a weight average molecular weight of 25,000 g/mol (PANLITE L-1250W, Teijin Kasei K.K., Japan), followed by extrusion at 200 to 280° C. using a general biaxial extruder to thereby prepare pellets. These pellets are dried at 70° C. for 2′ hours and formed into a specimen using a 10 oz injection molder at a molding temperature of 180 to 280° C. and a mold temperature of 40 to 80° C.

Physical properties of the prepared specimens are evaluated as follows, and the results are shown in Table 2.

(1) Flame retardancy: Flame retardancy is measured on a ⅛″ thick specimen according to UL 94 VB standards.

(2) Total combustion time: Total combustion time is measured on a ⅛″ thick specimen according to UL 94 standards.

(3) Heat resistance: Vicat softening temperature (VST) is measured using a 5 kg weight according to ISO R 306.

(4) IZOD impact strength: IZOD impact strength is measured on a ⅛″ thick notched specimen at room temperature according to ASTM D256 (kgf·cm/cm).

TABLE 2

| | Example 1 | Example 2 | Example 3 |
|---|---|---|---|
| Polycarbonate resin | 100 | 100 | 100 |
| Cross-linked polyphosphonate | 2 | 3 | 5 |
| (parts by weight) | | | |
| Flame retardancy (UL94, ⅛″) | V-0 | V-0 | V-0 |
| Total combustion time (sec) | 1 | 0 | 0 |
| Heat resistance (° C.) | 151 | 151 | 150 |
| IZOD (room temperature) | 85 | 83 | 82 |

### Comparative Examples 1 to 9

Specimens are formed of compositions of Comparative Examples 1-9 using the same process as in Example 1 except that the following flame retardants are used in the amounts listed in Table 3 instead of the cross-linked polyphosphonate. The units of the amounts of the polycarbonate and flame retardants are parts by weight. The physical properties of the specimens are also evaluated in the same manner as described herein and the results are shown in Table 3.

TABLE 3

| | | Comparative Example | | | | | | | | |
|---|---|---|---|---|---|---|---|---|---|---|
| | | 1 | 2 | 3 | 4 | 5 | 6 | 7 | 8 | 9 |
| Polycarbonate | | 100 | 100 | 100 | 100 | 100 | 100 | 100 | 100 | 100 |
| Flame | (a) | 2 | 3 | 5 | — | — | — | — | — | — |
| retardant | | | | | | | | | | |
| Flame | (b) | — | — | — | 2 | 3 | 5 | — | — | — |
| retardant | | | | | | | | | | |
| Flame | (c) | — | — | — | — | — | — | 2 | 3 | 5 |
| retardant | | | | | | | | | | |

| | | | | | | | | | |
|---|---|---|---|---|---|---|---|---|---|
| Flame | V-2 | V-2 | V-2 | V-2 | V-2 | V-2 | V-0 | V-0 | V-0 |
| retardancy | (drip) | (drip) | (drip) | (drip) | (drip) | (drip) | | | |
| Total | 48 | 34 | 26 | 61 | 45 | 32 | 11 | 3 | 1 |
| combustion | | | | | | | | | |
| time (sec) | | | | | | | | | |
| Heat | 141 | 139 | 131 | 144 | 140 | 138 | 145 | 144 | 141 |
| resistance (° C.) | | | | | | | | | |
| IZOD (room | 68 | 66 | 63 | 78 | 75 | 71 | 80 | 77 | 76 |
| temperature) | | | | | | | | | |

(a) CR-741S (Trade name, Daihachi, Japan)
(b) PX-200 (Trade name, Daihachi, Japan)
(c) Polyphosphonate having molecular weight (Mw) of 12,000 obtained by reaction of 2,2-bis-(4-hydroxyphenyl)-propane with phenylphosphonic acid dichloride and substitution of a terminal group by 4-cumylphenol

As shown in Tables 2 and 3, the thermoplastic resin compositions using the cross-linked polyphosphonate according to Examples 1 to 3 have excellent flame retardancy, heat resistance, and impact strength. However, the compositions using monomolecular flame retardants according to Comparative Examples 1 to 6 have deteriorated flame retardancy of V-2 or a decreased total combustion time, and the compositions using a linear polyphosphonate according to Comparative Examples 7 to 9 also have reduced heat resistance and impact strength.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A cross-linked polyphosphonate comprising a unit represented by Formula 1: 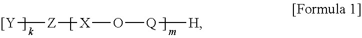
wherein:
Z is a greater than trivalent C1 to C30 hydrocarbon residue,
each Y is the same or different and is independently hydrogen, C1 to C5 linear or branched alkyl, C5 to C6 cycloalkyl or C6 to C20 aryl,
each X is the same or different and is independently C1 to C5 linear or branched alkylene, C5 to C6 cycloalkylene or C6 to C20 arylene,
each Q is the same or different and is independently 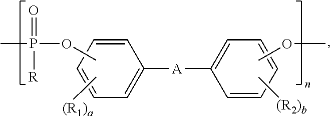
wherein A is a single bond, C1 to C5 alkylene, C1 to C5 alkylidene, C5 to C6 cycloalkylidene, —S— or —SO2-, R is C1 to C10 alkyl, C6 to C20 aryl or C6 to C20 aryloxy, R₁ and R₂ are the same or different and are each independently substituted or unsubstituted C1 to C6 alkyl, substituted or unsubstituted C3 to C6 cycloalkyl, substituted or unsubstituted C6 to C12 aryl or halogen, a and b are the same or different and are each independently an integer from 0 to 4, and n is an integer from 5 to 2,000,
k is an integer from 0 to 10, and
m is an integer from 3 to 10.

2. The cross-linked polyphosphonate of claim 1, wherein the cross-linked polyphosphonate has a solubility of about 0 to about 0.0001 g/10 ml in tetrahydrofuran when deposited at 25° C. for 17 hours.

3. The cross-linked polyphosphonate of claim 1, wherein the cross-linked polyphosphonate has a weight average molecular weight of about 1,000 to about 300,000 g/mol.

4. The cross-linked polyphosphonate of claim 1, wherein Q is present in an amount of 50 to about 98 wt % based on the total weight of the cross-linked polyphosphonate.

5. The cross-linked polyphosphonate of claim 1, wherein the cross-linked polyphosphonate is represented by Formula 1-1: 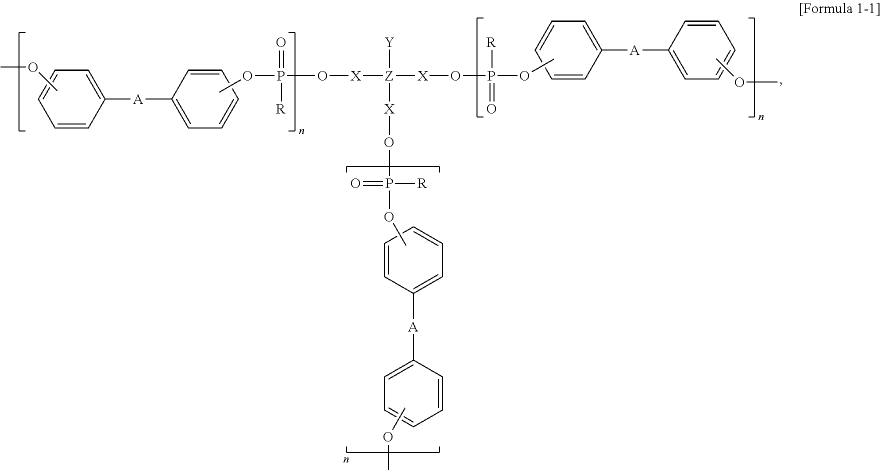
wherein:
Z is C1 to C5 linear or branched alkyl, C5 or C6 cycloalkyl, or C6 to C20 aryl,
Y is hydrogen, C1 to C5 linear of branched alkyl, C5 or C6 cycloalkyl, or C6 to C20 aryl,
each X is the same or different and is independently C1 to C5 linear or branched alkylene, C5 or C6 cycloalkylene, or C6 to C20 arylene,
each A is the same or different and is independently a single bond, C1 to C5 alkylene, C1 to C5 alkylidene, C5 or C6 cycloalkylidene, —S—, or —SO2-,
each R is the same or different and is independently C1 to C10 alkyl, C6 to C20 aryl, or C6 to C20 aryloxy, and
each n is the same or different and is independently an integer from 5 to 2,000.

6. The cross-linked polyphosphonate of claim 1, wherein Z comprises one or more of the following units: 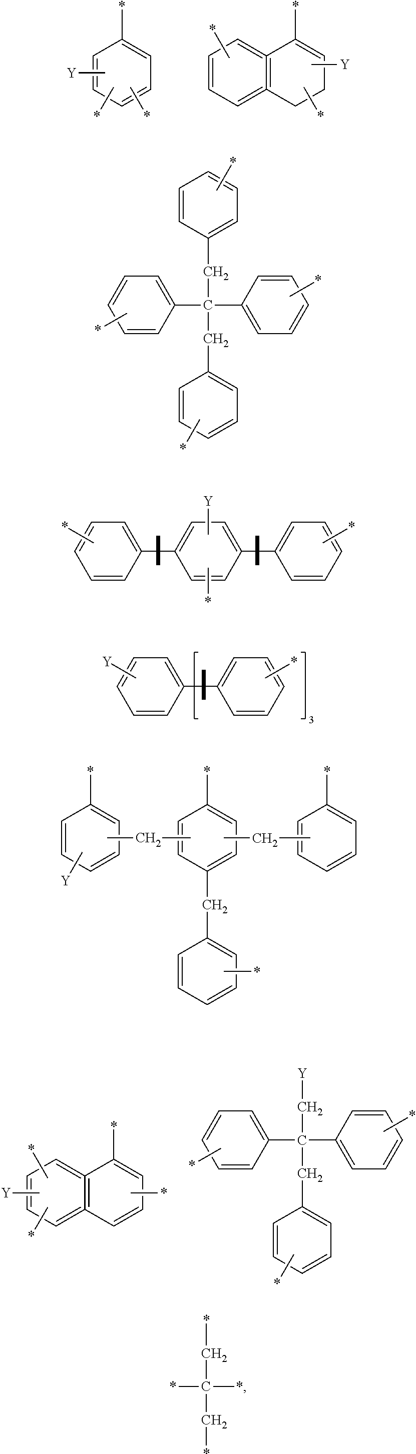
where * is

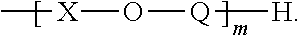

7. A method of preparing cross-linked polyphosphonate comprising a unit represented by Formula 1, comprising: polymerizing a diol represented by Formula 2 and phosphonic dichloride represented by Formula 3 with a crosslinker represented by Formula 4: 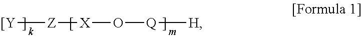
wherein:
Z is a greater than trivalent C1 to C30 hydrocarbon residue,
each Y is the same or different and is independently hydrogen, C1 to C5 linear or branched alkyl, C5 to C6 cycloalkyl or C6 to C20 aryl,
each X is the same or different and is independently C1 to C5 linear or branched alkylene, C5 to C6 cycloalkylene or C6 to C20 arylene,
each Q is the same or different and is independently 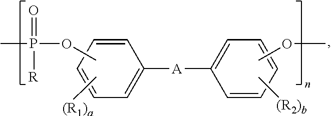
wherein A is a single bond, C1 to C5 alkylene, C1 to C5 alkylidene, C5 to C6 cycloalkylidene, —S— or —SO2-, R is C1 to C10 alkyl, C6 to C20 aryl or C6 to C20 aryloxy, R₁ and R₂ are the same or different are each independently substituted or unsubstituted C1 to C6 alkyl, substituted or unsubstituted C3 to C6 cycloalkyl, substituted or unsubstituted C6 to C12 aryl or halogen, a and b are the same or different and are each independently an integer from 0 to 4, and n is an integer from 5 to 2,000,
k is an integer from 0 to 10, and
m is an integer from 3 to 10; 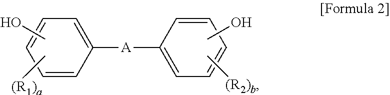
wherein:
A is a single bond, C1 to C5 alkylene, C1 to C5 alkylidene, C5 to C6 cycloalkylidene, —S— or —SO2-,
R₁ and R₂ are the same or different and are each independently substituted or unsubstituted C1 to C6 alkyl, substituted or unsubstituted C3 to C6 cycloalkyl, substituted or unsubstituted C6 to C12 aryl or halogen, and
a and b are the same or different and are each independently an integer from about 0 to about 4; 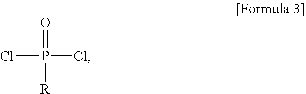
wherein R is C6 to C20 aryl or C6 to C20 aryloxy; and 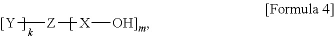
wherein:
Z is a greater than trivalent C1 to C30 hydrocarbon residue,
each Y is the same or different and is independently hydrogen, C1 to C5 linear or to branched alkyl, C5 to C6 cycloalkyl or C6 to C20 aryl,
each X is the same or different and is independently C1 to C5 linear or branched alkyl, C5 to C6 cycloalkyl or C6 to C20 aryl,
k is an integer from 0 to 10, and
m is an integer from 3 to 10.

8. The method of claim 7, wherein the crosslinker is reacted with the phosphonic dichloride in an equivalent ratio of about 0.01:1 to about 1:1.

9. The method of claim 7, wherein the polymerization is carried out in the presence of a basic catalyst.

10. The method of claim 7, wherein the polymerization is carried out by interfacial polymerization in the presence of at least one catalyst comprising tetrabutylammonium iodide, tetrabutylammonium bromide, benzyltriphenylphosphonium chloride or a combination thereof.

11. The method of claim 7, further comprising adjusting a terminal group with a phenolic compound.

12. The method of claim 11, wherein the phenolic compound is reacted with the phosphonic dichloride in an equivalent ratio of about 0.03:1 to about 0.3:1.

13. A flame retardant thermoplastic resin composition comprising the cross-linked polyphosphonate of claim 1.

14. The flame retardant thermoplastic resin composition of claim 13, wherein the composition comprises about 0.01 to about 30 parts by weight of the cross-linked polyphosphonate based on about 100 parts by weight of thermoplastic resin.

15. The flame retardant thermoplastic resin composition of claim 13, wherein the flame retardant thermoplastic resin composition has an IZOD impact strength of about 80 kgf·cm/cm or more as measured on a ⅛″ thick specimen according to ASTM D256, a total combustion time of less than about 3 seconds as measured on a ⅛″ thick specimen according to UL-94, and a Vicat softening temperature (VST) of about 150° C. or higher as measured using a 5 kg weight according to ISO R 306.
